(19) United States
(12) Patent Application Publication
(10) Pub. No.: US 2020/0378839 A1
(43) Pub. Date: Dec. 3, 2020

(54) THERMOCOUPLE, TEMPERATURE MEASURING SYSTEM AND METHOD FOR PRODUCING A THERMOCOUPLE

(71) Applicant: AVL List GmbH, Graz (AT)

(72) Inventor: Ernst FUCHS, Kuberg (AT)

(73) Assignee: AVL List GmbH, Graz (AT)

(21) Appl. No.: 16/955,069

(22) PCT Filed: Dec. 21, 2018
(86) PCT No.: PCT/AT2018/060314

§ 371 Date: Jun. 18, 2020

(30) Foreign Application Priority Data
Dec. 21, 2017 (AT) A5106082017

(51) Int. Cl. G01K 7/06; G01K 7/10

(52) U.S. Cl. CPC G01K 7/06; G01K 7/10

(57) ABSTRACT

The present invention relates to a thermocouple (1) for measuring the temperature of a high-voltage component, having a metal first conductor (2) made of a first material and a metal second conductor (3) made of a second material, wherein the first material differs from the second material, wherein the first conductor (2) and the second conductor (3) are mechanically asymmetrical and electrically symmetrical with respect to one another. The invention also relates to a temperature measuring system (10) having the thermocouple (1) according to the invention and to a method for producing a thermocouple (1) according to the invention.

The present invention relates to a thermocouple for measuring the temperature of a high-voltage component, having a metal first conductor made of a first material and a metal second conductor made of a second material, the first material differing from the second material. The invention also relates to a temperature measuring system with a thermocouple and to a method for producing a thermocouple.

Temperature measurements by means of a thermocouple are sufficiently well known in the prior art. For example, a thermocouple of the type in question is disclosed by JP 2016-011880 A2.

Thermocouples generally produce very small voltages, depending on the material pairing in a range from about 6 μV/K to about 42 μV/K. For improved measuring accuracy, thermocouples are therefore often shielded, so that interferences of these voltages, and consequently the measurement results, are influenced as little as possible. However, shieldings are expensive. What is more, it is often not possible for such a shielding to be provided throughout, for example in the case of adapter plugs, as a result of which measuring errors can still be caused by interferences.

A further measure for allowing the possible problems with regard to the interference of the voltages produced by the thermocouple to be taken into account is for the measuring inputs to be highly filtered. However, this leads to slow measurements, and consequently to correspondingly slowly reacting operational processes. Thermal changes are brought about relatively slowly on large masses, for which reason slow measuring methods may be sufficient on such measurement objects. If, however, measurement objects are small, and therefore have a small thermal time constant, a sensor with a low thermal inertia must also be used on a thermocouple in order to be able to measure the rapid temperature changes correspondingly quickly.

In these cases, satisfactory filtering is scarcely feasible. It must also be taken into consideration here that, the longer a measuring line has to be, the greater the interfering influence, and consequently also the measuring error.

In the case of measurements at a high voltage level, the sensor tip on known thermocouples is electrically insulated. Consequently, the sensor tip is also thermally insulated and leads to the already mentioned slow or slowly reacting measurements. If the measurement object is at high potential, filter capacitors are often no longer possible for multichannel measuring systems with the existing space available, in particular in the case of modern miniaturized construction, because of their overall size. Such measurement objects may be busbars on converter systems or batteries, which are subjected to great and high-frequency common-mode interferences. Common-mode interferences make a symmetrical measuring input a pre-requisite, since otherwise common-mode interferences become series-mode interferences, which can act as measuring errors.

The object of the present invention is to overcome at least partially the disadvantages described above. In particular, the object of the present invention is to provide a thermocouple and a temperature measuring system by means of which temperatures and/or quickly changing temperatures, including in the high-voltage range, can be measured in an easy, robust, low-cost and interference-immune way. Furthermore, an object of the present invention is to provide a method for producing a thermocouple according to the invention.

The aforementioned object is achieved by the patent claims. In particular, the aforementioned object is achieved by the thermocouple according to claim 1, the temperature measuring system according to claim 10 and the method for producing a thermocouple according to claim 11. Further advantages of the invention are provided by the subclaims, the description and the drawings. It goes without saying here that features and details that are described in connection with the thermocouple also apply in connection with the temperature measuring system according to the invention and the method according to the invention for producing the thermocouple, and conversely in each case, so that reference is or can always be made from one to the other with respect to the disclosure in relation of the individual aspects of the invention.

According to a first aspect of the present invention, a thermocouple for measuring the temperature of a high-voltage component is provided. The thermocouple has a metal first conductor made of a first material and a metal second conductor made of a second material, the first material differing from the second material. According to the invention, the first conductor and the second conductor are mechanically asymmetrical and electrically symmetrical with respect to one another.

In the application of thermocouples, very small voltage differences in the range of a few pV/K must be measured very accurately. In the area affected by interferences, for example in the vicinity of spark plugs or busbars of converters, until now the focus has always been on the shielding, short line lengths, electrical insulation and/or filtering of the small measuring signals. This has overlooked the fact that the cause lies in the asymmetry of the material pairing.

The mechanical asymmetry is achieved in particular by the first conductor and the second conductor having cross-sectional areas of different sizes. Thus, the first conductor may for example have a cross-sectional area that is at least partly greater than the cross-sectional area of the second conductor, or vice versa. In this case, the difference in the cross-sectional areas is chosen such that the electrical symmetry between the two conductors is obtained. The electrical symmetry should be understood as meaning that the first conductor and the second conductor each have the same, or substantially the same, resistance per unit length.

This allows the creation of thermocouples of any desired length which, when subjected to common-mode interferences, can deliver an error-free and interference-immune measuring signal even without shielding. It has been found in extensive tests conducted in the context of the present invention that it is possible to dispense with insulation of the sensor tip of the thermocouple and shielding if the construction of the lines is electrically symmetrical, that is to say if the electrical resistance per unit length of the first line is equal to the electrical resistance per unit length of the second line. Preferably, the length of the first line is also equal to the length of the second line. Consequently, particularly preferably, the absolute electrical resistance of the first line is equal to the absolute electrical resistance of the second line.

Consequently, in particular temperature measurements at a high voltage level or with high-frequency common-mode interferences can be measured while immune from interference without additional thermal inertia or a time delay. The length of the measuring line in this case does not influence the interference sensitivity or the potential measuring error.

The thermocouple is suitable for reliable temperature measurement of a high-voltage component in the area of high potential differences and high voltages. The thermocouple should be understood as meaning in particular a thermoelectric measuring device for recording a temperature difference. The thermocouple according to the invention should consequently be differentiated in particular from the technical area of pyroelectric measuring systems, which are designed for determining temperature changes. Recording the temperature difference should be understood as meaning that measurements are taken at two different locations at the same time and the temperature difference between the two locations can be determined on the basis of the voltage measured. If the temperature of the first location is known, the temperature of the second location can consequently be determined. By contrast, determining the change of temperature should be understood as meaning that measurements are taken at the same location at different times and only the difference in temperature at the different times is determined, while the actual temperature at the measuring location is not determined thereby.

Measuring the temperature of the high-voltage component should preferably be understood as meaning measuring a changing temperature on a high-voltage component, in particular measuring a changing temperature of at least a portion of the high-voltage component.

The metal first conductor may consist completely, or substantially completely, of metal. Similarly, the metal second conductor may consist completely, or substantially completely, of metal.

According to a development, it is possible in the case of a thermocouple according to the invention that the first conductor has a higher resistivity than the second conductor and the cross-sectional area of the first conductor is greater than the cross-sectional area of the second conductor by the factor, or substantially the factor, by which the resistivity of the first conductor is higher than the resistivity of the second conductor. That is to say that the line cross sections should be proportional to the resistivities. This results in two lines with a resistance per unit length that is as equal as possible. As a result, the electrical symmetry can be realized particularly reliably with the desired mechanical asymmetry. In such a system, correspondingly interference-immune measured values can be expected.

It is also possible that, in the case of a thermocouple according to the present invention, the first conductor consists of chromium nickel or iron, or predominantly chromium nickel or iron, and the second conductor consists of nickel or copper nickel, or predominantly nickel or copper nickel. Nickel and chromium nickel and also iron and copper nickel have been found in tests conducted in the context of the present invention to be low-cost and reliably functioning metal pairings.

According to a further configurational variant, in the case of a thermocouple of the present invention, the first conductor and the second conductor are in each case configured in the form of a wire. As a result, the thermocouple can be configured in a particularly simple and space-saving form. The configuration in the form of a wire should be understood in particular as meaning a thin, long and flexible geometry with a round cross section.

In this way it is possible with the present invention that, in the case of a thermocouple, a tubular first insulating sheathing is formed at least partly around the first conductor and a tubular second insulating sheathing is formed at least partly around the second conductor.

As a result, the thermocouple can still be provided in a structurally simple and space-saving form. The insulating sheathing is preferably configured as an electrically insulating sheathing. That is to say that the insulating sheathing preferably corresponds to an electrical insulator with a high mechanical load-bearing capacity and a negligible electrical conductivity. The insulating sheathing is preferably a high-voltage insulating sheathing. The insulating sheathing can prevent a current flow between the first conductor and the second conductor.

It is also possible that, in the case of a thermocouple according to the present invention, at least partly around the first conductor, the second conductor, the first insulating sheathing and the second insulating sheathing there is formed a common third insulating sheathing. As a result, the simple and space-saving construction according to the invention can be provided in a particularly robust form with respect to external force effects. The third insulating sheathing also allows the first conductor and the second conductor and also the first insulating sheathing and the second insulating sheathing to be reliably kept in the desired position.

According to a further configurational variant of the present invention, it is possible that, in the case of a thermocouple, the first conductor and the second conductor are at least partly twisted together. As a result, the mechanical structure of the thermocouple can be provided in a particularly robust form. The first conductor and the second conductor are preferably twisted together with only a single twist. This also allows the thermocouple to be provided in a particularly simple construction.

It is also possible that, in the case of a thermocouple according to the invention, an outer circumferential surface of the first insulating sheathing lies at least partly against an outer circumferential surface of the second insulating sheathing. Also in this way, the thermocouple can be provided in a particularly compact and robust form, whereby reliable operation of the thermocouple can be ensured.

It may also be of advantage if, in the case of a thermocouple according to the present invention, the first conductor, the second conductor, the first insulating sheathing, the second insulating sheathing and/or the third insulating sheathing are flexibly configured. As a result, the thermocouple can be used correspondingly flexibly. Also, damage to the thermocouple under the effect of external forces can be prevented by the flexibility of the thermocouple, in that the thermocouple can evade the forces acting. As a result, reliable operation of the thermocouple can in turn be ensured. A flexible component should be understood as meaning a component that is, at least to a certain extent, elastically deformable under the effect of a force.

According to a further aspect of the present invention, a temperature measuring system for measuring a temperature is made available. The temperature measuring system has a thermocouple as described in detail above, an analog-digital converter and a microprocessor in signaling connection with the analog-digital converter. Consequently, a temperature measuring system according to the invention brings with it the same advantages as described in detail with reference to the thermocouple according to the invention. The microprocessor may be understood as meaning generally an electronic open-loop and closed-loop control unit. For the temperature measuring system to operate in a reliable way, the microprocessor is arranged such that it is electrically insulated from the analog-digital converter, preferably by an insulation, in particular by an electrical insulation. This means that the insulation is arranged for electrical insulation between the microprocessor and the analog-digital converter.

In addition, within the scope of the present invention, a method for producing a thermocouple as described above is made available. The method has the following steps:
providing the first conductor, with the first insulating sheathing,
providing the second conductor, with the second insulating sheathing,
at least partly twisting the first conductor, which is located within the first insulating sheathing, with the second conductor, which is located within the second insulating sheathing, and
at least partly sheathing the twisted conductors with the third insulating sheathing.

The method is preferably carried out by machine, in an automated manner. As a result, the thermocouple can be provided quickly, at low cost and with high quality.

Further measures that improve the invention will become apparent from the following description of various exemplary embodiments of the invention, which are schematically illustrated in the figures. All of the features and/or advantages which emerge from the claims, the description or the drawing, including design details and spatial arrangements, may be essential to the invention both on their own and in the various combinations.

In the respective schematic figures:

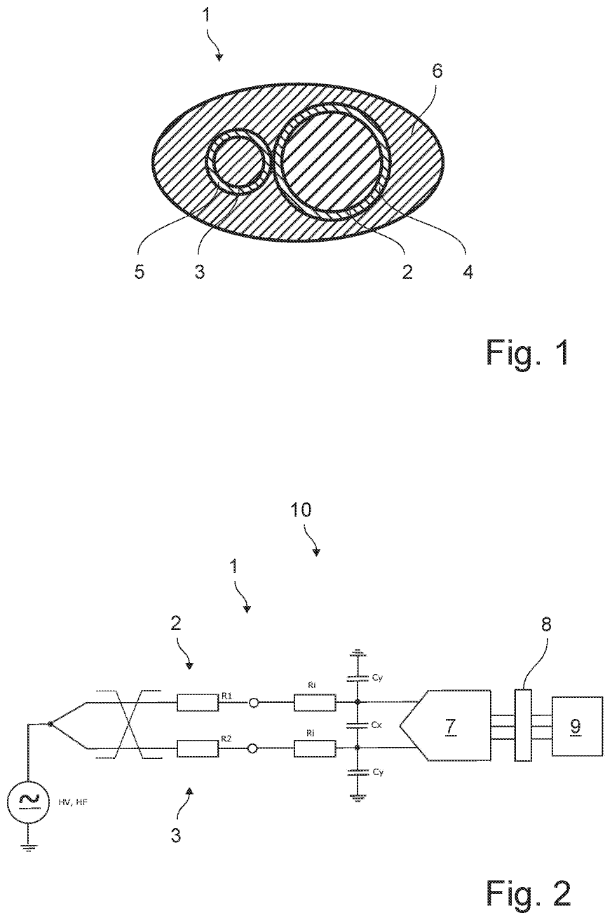

FIG. 1 shows a sectional view of a thermocouple according to an embodiment according to the invention, and

FIG. 2 shows an equivalent circuit diagram for a temperature measuring system according to the invention.

Elements with the same function and mode of operation are each provided with the same reference signs in FIGS. 1 and 2.

In FIG. 1, a thermocouple 1 for measuring the temperature of a high-voltage component is schematically illustrated. The thermocouple 1 has a metal first conductor 2 made of chromium nickel and a metal second conductor 3 made of nickel. As can be seen in the sectional view in FIG. 1, the first conductor 2 has a greater cross-sectional area than the second conductor 3. As a result, the first conductor 2 and the second conductor 3 are mechanically asymmetrical with respect to one another. Nevertheless, as a result of the chosen metal pairing, the first conductor 2 and the second conductor 3 are electrically symmetrical with respect to one another. In the present example, the first conductor 2 made of chromium nickel has a higher resistivity than the second conductor 3 made of nickel, the cross-sectional area of the first conductor 2 being greater than the cross-sectional area of the second conductor 3 by the factor, or substantially the factor, by which the resistivity of the first conductor 2 is higher than the resistivity of the second conductor 3 to obtain an electrical symmetry that is as ideal as possible. Possible as a further metal pairing would be iron for the first conductor 2 and copper nickel for the second conductor 3.

As can also be seen in FIG. 1, the first conductor 2 and the second conductor 3 are in each case configured in the form of a wire with a round cross section. As a result, the first conductor 2 and the second conductor 3 are correspondingly flexibly configured. At the same time, a tubular first insulating sheathing 4 is formed around the first conductor 2 and a tubular second insulating sheathing 5 is formed around the second conductor 3. Furthermore, around the first conductor 2, the second conductor 3, the first insulating sheathing 4 and the second insulating sheathing 5 there is formed a common third insulating sheathing 6. That is to say that the third insulating sheathing 6 is in direct contact with the first insulating sheathing 4 and the second insulating sheathing 5, the first conductor 2 being kept at a distance from the third insulating sheathing by the first insulating sheathing 4 and the second conductor 3 being kept at a distance from the third insulating sheathing by the second insulating sheathing 5.

The first conductor 2 and the second conductor 3, including the respective insulating sheathing 4, 5, are twisted together with a single twist. An outer circumferential surface of the first insulating sheathing 4 in this case lies against an outer circumferential surface of the second insulating sheathing 5.

With reference to FIG. 1, a method for producing the illustrated thermocouple 1 or the portion according to the invention of the thermocouple 1 is to be described hereafter. In a first step S1, for this purpose the first conductor 2, with the first insulating sheathing 4, and the second conductor 3, with the second insulating sheathing 5, are provided. In a subsequent second step S2, the first conductor 2 in the first insulating sheathing 4 and the second conductor 3 in the second insulating sheathing 5 are twisted together. After that, the twisted conductors 2, 3, which are in the respective insulating sheathing 4, 5, are sheathed with the third insulating sheathing 6.

In FIG. 2, an equivalent circuit diagram of a temperature measuring system 10 for measuring a temperature on a high-voltage measurement object by means of the thermocouple 1 described above is illustrated. The temperature measuring system has for this purpose the thermocouple 1, an analog-digital converter 7 and a microprocessor 9 in signaling connection with the analog-digital converter 7. The microprocessor 9 is arranged such that it is electrically insulated from the analog-digital converter 7 by an insulation 8. As can be seen in FIG. 2, the first conductor 2 of the temperature measuring system 10 has a different electrical resistance than the second conductor 3.

Apart from the embodiments illustrated, the invention allows further configuration principles. That is to say that the invention should not be regarded as restricted to the embodiments illustrated in the figures.

### LIST OF REFERENCE SIGNS

1 thermocouple

2 first conductor

3 second conductor

4 first insulating sheathing

5 second insulating sheathing

6 third insulating sheathing

7 analog-digital converter

8 insulation

9 microprocessor

10 temperature measuring system

In the claims:

1. A thermocouple (1) for measuring the temperature of a high-voltage component, having a metal first conductor (2) made of a first material and a metal second conductor (3) made of a second material, the first material differing from the second material, characterized in that the first conductor (2) and the second conductor (3) are mechanically asymmetrical and electrically symmetrical with respect to one another.

2. The thermocouple (1) as claimed in claim 1, characterized in that the first conductor (2) has a higher resistivity than the second conductor (3) and the cross-sectional area of the first conductor (2) is greater than the cross-sectional area of the second conductor (3) by the factor, or substantially the factor, by which the resistivity of the first conductor (2) is higher than the resistivity of the second conductor (3).

3. The thermocouple (1) as claimed in claim 1, characterized in that the first conductor (2) consists of chromium nickel or iron, or predominantly chromium nickel or iron, and the second conductor (3) consists of nickel or copper nickel, or predominantly nickel or copper nickel.

4. The thermocouple (1) as claimed in claim 1, characterized in that a tubular first insulating sheathing (4) is formed at least partly around the first conductor (2), which is in particular configured in the form of a wire, and a tubular second insulating sheathing (5) is formed at least partly around the second conductor (3), which is in particular configured in the form of a wire.

5. The thermocouple (1) as claimed in claim 4, characterized in that at least partly around the first conductor (2), the second conductor (3), the first insulating sheathing (4) and the second insulating sheathing (5) there is formed a common third insulating sheathing (6).

6. The thermocouple (1) as claimed in claim 1, characterized in that the first conductor (2) and the second conductor (3) are at least partly twisted together.

7. The thermocouple (1) as claimed in claim 4, characterized in that an outer circumferential surface of the first insulating sheathing (4) lies at least partly against an outer circumferential surface of the second insulating sheathing (5).

8. The thermocouple (1) as claimed in claim 1, characterized in that the first conductor (2), the second conductor (3), the first insulating sheathing (4), the second insulating sheathing (5) and/or the third insulating sheathing (6) are flexibly configured.

9. A temperature measuring system (10) for measuring a temperature, having a thermocouple (1) as claimed in claim 1, an analog-digital converter (7) and a microprocessor (9) in signaling connection with the analog-digital converter (7).

10. A method for producing a thermocouple (1) as claimed in claim 1, having the following steps:
providing the first conductor (2), with the first insulating sheathing (4),
providing the second conductor (3), with the second insulating sheathing (5),
at least partly twisting the first conductor (2), which is located within the first insulating sheathing (4), with the second conductor (3), which is located within the second insulating sheathing (5), and
at least partly sheathing the twisted conductors (2, 3) with the third insulating sheathing (6).
